(19) United States
(12) Patent Application Publication
(10) Pub. No.: US 2005/0248825 A1
(43) Pub. Date: Nov. 10, 2005

(54) Reversible electrodeposition optical modulation device with conducting polymer counter electrode

(75) Inventors: Leslie F. Warren JR., Camarillo, CA (US); D. Morgan Tench, Camarillo, CA (US)

Correspondence Address: JOHN J. DEINKEN, 1049 CAMINO DOS RIOS, P. O. BOX 1085, THOUSAND OAKS, CA, 91358-0085, US

(73) Assignee: Rockwell Scientific Licensing, LLC

(21) Appl. No.: 10/839,060

(22) Filed: May 4, 2004

(51) Int. Cl. G02F 1/15

(52) U.S. Cl. 359/265

(57) ABSTRACT

An optical modulation device includes an electrolyte containing electrodepositable metal ions sandwiched between a conducting polymer counter electrode and an optical modulation electrode involving reversible metal electrodeposition. The conducting polymer counter electrode does not generate mobile reactive species, and avoids the light blocking associated with grid or dot matrix electrodes involving reversible metal electrodeposition. A polyaniline counter electrode in a smart window device employing a reversible electrochemical mirror modulation electrode provides high light transmission, fast switching, and coloration to mask the backside of the mirror electrode.

### CROSS-REFERENCE TO RELATED APPLICATIONS

This application is related to U.S. Pat. Nos. 5,903,382, 5,923,456, 6,111,685, 6,166,847, 6,256,135, 6,301,039, 6,400,491 and 6,552,843, and to U.S. patent application, Ser. No. 10/211,494, filed Aug. 1, 2002 (entitled “Locally-Distributed Electrode and Method of Fabrication”), Ser. No. 10/256,841, filed Sep. 27, 2002, (entitled “Optimum Switching of a Reversible Electrochemical Mirror Device), and Ser. No. 10/355,760, filed 31 Jan. 2003 (entitled “Locally-Switched Reversible Electrodeposition Optical Modulator”), all of which are assigned to the assignee of the present application. The teaching of each of these patents and patent applications is incorporated herein by reference.

### U.S. GOVERNMENT RIGHTS

This invention was made with Government support under Contract No. DE-FC26-03NT-41951 awarded by the Department of Energy. The Government has certain rights in this invention.

### BACKGROUND OF THE INVENTION

1. Field of the Invention

This invention is concerned with devices, such as smart windows and optical attenuators, for controlling the transmission and reflectance of electromagnetic radiation.

2. Description of the Related Art

Smart windows are designed to reduce the amount of energy consumed for climate control of buildings and transportation vehicles by controlling the amount of solar radiation that is transmitted into such buildings and vehicles, which produces interior heating via the greenhouse effect. However, the electrochromic smart window devices which are known in the prior art have narrow dynamic ranges and involve light absorption during operation, resulting in heat being generated and transferred into the interior space by conduction, convection and infrared radiation. In addition, electrochromic devices typically utilize a relatively slow ion insertion electrochemical process that limits switching speed and cycle life. Heating of electrochromic devices by light absorption further reduces the device lifetime. Other types of smart windows, such as liquid crystal and suspended particle devices, also have limited dynamic range and typically have the added disadvantage of requiring a continuously applied voltage to maintain a given transmissive state. Consequently, an important need exists for a durable, low-power smart window with reflectivity variable over a wide range. A smart window device based on light reflection would be much more efficient at preventing interior heating.

U.S. Pat. Nos. 5,923,456 and 5,903,382 to Tench et al. describe a reversible electrochemical mirror (REM) smart window device that provides the adjustable light reflection, wide dynamic range, long cycle life and low power requirements needed for a high efficiency smart window. In a transmissive type REM device, a mirror metal is reversibly electrodeposited (from a thin layer of liquid or gelled electrolyte) on a transparent electrode to form a full or partial mirror, which provides variable reflectivity. Conversely, the mirror metal is deposited on a locally distributed counter electrode (a metallic grid on glass, for example) to reduce the reflectivity and increase the amount of light transmitted. The mirror metal is preferably silver but may be another metal, such as bismuth, copper, tin, cadmium, mercury, indium, lead, antimony, thallium, zinc, or an alloy. The transparent electrode is typically indium tin oxide (ITO) or fluorine-doped tin oxide (FTO), with a thin layer of noble metal (e.g., 15 Å platinum) that serves as a nucleation layer so that suitably smooth, mirror deposits can be obtained. The transmission of visible light, with continuous variability from around 80% to complete blocking, has been demonstrated and higher transmission for some device configurations and switching conditions should be attainable. Intermediate mirror states provide good visibility and have a pleasing bluish-gray appearance. Very little voltage is required for switching REM devices, and no voltage is needed to maintain a given switched state. As described in U.S. Pat. No. 6,301,039 to Tench, the decrease in mirror electrode sheet resistance produced by deposition of mirror metal on the mirror electrode can be used to monitor the reflectance state of the REM mirror.

Commercialization of REM smart window devices has been hindered by the expense and performance of the locally distributed counter electrode, which must present a relatively small cross-sectional area to avoid excessive light blockage that would decrease the maximum transmission of the device. One counter electrode approach, described in U.S. Pat. No. 5,903,382 to Tench et al., is to use a grid of a noble metal (platinum with a chromium adhesion layer, for example) that is vacuum evaporated through a photolithographic mask onto a glass substrate. The photolithographic process is inherently expensive and not readily scalable to large areas. In addition, fine grid lines (<10 μm wide) are needed so as to be invisible to the eye, but grid lines of such size are prone to damage during the photoresist liftoff process, which further increases the fabrication costs. Fine grid lines also tend to produce light interference patterns that distort images seen through the window. Furthermore, grid lines, even with mirror metal deposited on them, are relatively flat so that their actual area and cross-sectional area are nearly the same. Consequently, the current carrying capability for such grids with good light transmission is very low (approximately 5-10% of that for the mirror electrode).

An alternative approach for transmissive devices is to use the dot matrix counter electrode described in U.S. patent application Ser. No. 10/211,494 to Tench (filed Aug. 1, 2002), which is assigned to the same assignee as the present invention. Such an electrode comprises microscopic islands of a noble metal (e.g., Pt) distributed over a layer of a transparent metallic oxide conductor (e.g., ITO or FTO), which serves as the current collector. During device operation, mirror metal is reversibly deposited on the noble metal islands, which are produced by electrodeposition at active sites on the transparent conductor surface (without photolithography). Extraneous mirror metal deposition does not occur, since the potential required for mirror metal deposition on the bare metallic oxide surface is generally greater than on the noble metal islands. For spherical islands, the surface area is roughly three times the cross-sectional area and the current carrying capability is further increased via spherical diffusion. Sufficiently small islands are not visible to the naked eye.

Counter electrodes involving reversible mirror metal electrdeposition have significant disadvantages for REM devices, depending on the type of device. One disadvantage for transmissive devices is that a compromise is required, even for dot matrix electrodes, between maximum transmission and the counter electrode current carrying capability, which determines the device switching speed. Another disadvantage of the counter electrode used in current REM smart window devices is that the highly reflective mirror electrode deposit is visible from both sides, which may not be desirable for aesthetic reasons. Adjustable reflectivity REM mirrors employing counter electrodes based on reversible mirror metal electrodeposition have the disadvantage that electrical power is required to switch the mirror state, whereas failsafe to a full mirror upon loss of power is needed to meet automotive safety requirements. In addition, REM cells employing reversible metal electrodeposition at both electrodes must be charged initially with a fixed amount of silver, which may be lost via reaction with oxygen or electrolyte impurities, or may redistribute in the cell due to electrolyte convection or nonuniform voltage distribution. Furthermore, application of reversible electrodeposition (RED) technology to devices involving radio waves, reconfigurable antennas, for example, is hindered because free metal is always present in devices involving reversible metal electrodeposition at both electrodes.

Halide oxidation and halogen reduction have been employed in the prior art as the counter electrode reactions for display devices based on reversible metal electrodeposition, as described in U.S. Pat. No. 5,056,899 to Warszawski. In this case, halide oxidation provides the high voltage threshold needed for matrix addressing. At sufficiently high potentials for an ITO electrode, for example, bromide ion (Br⁻) may be oxidized to free bromine (Br°), which may be reduced back to bromide ion. Ostensibly, such a reversible halide/halogen reaction could also be used to avoid light blocking by metal on the counter electrode of a transmissive device employing reversible metal electrodeposition for light modulation. However, halogen (iodine, bromine or chlorine) produced at the counter electrode tends to diffuse through the electrolyte and cause spontaneous chemical dissolution of the metal deposit on the optical modulation electrode. Such self-erasure of the metal deposit is usually undesirable, particularly for smart window devices. Reactions involving free halogen from the counter electrode can also shorten the cell life by degrading transparent conductor electrode materials (ITO, for example) and/or by introducing chemical imbalances.

Consequently, important benefits could be provided by a counter electrode for reversible electrodeposition optical modulation devices that involved neither reversible metal electrodeposition nor generation of mobile reactive species, such as free halogen. It is an object of the present invention to provide such a counter electrode.

### SUMMARY OF THE INVENTION

This invention provides an optical modulation device for controlling the propagation of electromagnetic radiation comprising a conducting polymer counter electrode, an electrolyte containing ions of an electrodepositable metal, and an optical modulation electrode at which reversible metal electrodeposition occurs. In the absence of electrodeposited metal from the electrolyte, the optical modulation electrode is substantially transparent to radiation in the wavelength range for which propagation is to be controlled. During metal electrodeposition on the optical modulation electrode to increase reflectance and/or decrease transmission of radiation by the device, the conducting polymer counter electrode undergoes electrochemical oxidation, which is accompanied by transport of anions from the electrolyte to the conducting polymer, and/or cations from the conducting polymer to the electrolyte. During dissolution of the metal deposit from the optical modulation electrode to decrease reflectance and/or increase transmission of radiation by the device, the conducting polymer counter electrode undergoes electrochemical reduction, which is accompanied by transport of anions from the conducting polymer to the electrolyte, and/or cations from the electrolyte to the conducting polymer. In this case, counter electrode oxidation and reduction reactions are localized on the immobile conducting polymer so that no mobile energetic species are generated in the electrolyte. Note that the ions transported between the conducting polymer and the electrolyte do not undergo a change in oxidation state and, therefore, do not react with the metal deposit or cause a detrimental chemical imbalance in the electrolyte.

A wide variety of conducting polymers may be used for the counter electrode of the present invention, including polyaniline, polypyrrole, polythiophene, and derivatives and mixtures thereof. The conducting polymer is preferably deposed as a film on an electrically conducting substrate since oxidation/reduction of conducting polymers generally involves an insulating state, which would tend to cause nonuniform switching in the absence of a conducting substrate. Nonetheless, a conducting polymer film on an insulating substrate might be used for some devices according to the present invention. For a device involving transmission of radiation, the conducting polymer is preferably deposed as a film on a layer of transparent conductor, indium tin oxide (ITO) or fluorine doped tin oxide (FTO), for example, on a glass or plastic substrate. For adjustable reflectivity devices that do not involve radiation transmission, the conducting polymer may be deposed on an opaque electrical conductor, such as a metal sheet, or a thick metal film on an insulating or conducting substrate.

The conducting polymer film may be deposited by a variety of means, including electrochemical or chemical deposition from monomer or oligomer species dissolved in a solution, and spin, dip or spray coating of polymer species dissolved or suspended in a liquid. A thin layer of a metal (e.g., 15 Å Pt) or metallic oxide (ceria, for example) may be applied to the substrate or conducting layer to improve adhesion of the polymer film, or to protect the substrate or conducting layer from the electrolyte. Any metal or alloy providing adequate adhesion of the conducting polymer may be used as a substrate, or an adhesion/protection layer.

For the optical modulation device of the present invention, the electrolyte may be an aqueous or a nonaqueous solution but is preferably an ionic liquid, for which degradation of the polymer film by solvent species is avoided. The electrodepositable metal is preferably Ag, Cu, Bi or combinations thereof, but may comprise another metal. The optical modulation electrode may comprise any transparent conductor but is preferably an ITO or FTO film on a glass or plastic substrate. For reversible electrochemical mirror (REM) devices, the optical modulation electrode preferably also comprises a thin layer of a noble metal (e.g., 15 Å Pt), which acts as a nucleation layer so that mirror electrodeposits are obtained. For display devices, a nucleation layer may not be needed.

The conducting polymer counter electrode of the present invention is particularly advantageous for devices, such as smart windows, designed to control light transmission. A preferred REM smart window device comprises a polyaniline counter electrode (deposed as a film on 10-ohm/square ITO on a glass substrate), an ionic liquid electrolyte (consisting of a mixture of ethylmethylimidazolium chloride, butylmethylpyrrolidinium chloride and silver chloride), and a mirror electrode (15 Å Pt on 10-ohm/square ITO on glass). As preferred for smart window devices, polyaniline is colored (blue/green) in the oxidized state and is practically colorless in the reduced state. The smart window device is preferably assembled with no silver metal on the mirror electrode, and with the polyaniline film in the reduced state. During silver deposition on the mirror electrode to reduce light transmission, the reduced polyaniline film on the counter electrode is oxidized to the colored state so that the inside of the mirror electrode is obscured, which may be aesthetically or practically desirable. The maximum amount of silver deposited on the mirror electrode is limited by the charge capacity of the polyaniline film so that, at the switching endpoint, uniform silver thickness and uniform polyaniline coloration are ensured when the polyaniline film thickness is uniform. During dissolution of silver from the mirror electrode, the polyaniline counter electrode is reduced back to the optically clear state so that high light transmission may be attained. Use of a conducting polymer also permits the geometric area of the counter electrode to be the same as that of the mirror electrode so that it does not necessarily limit the device switching speed. This advantage is obtained without anodic generation of chemically active species in the electrolyte, which would react with the metal deposited on the optical modulation electrode and cause the optical properties of the device to drift with time.

A conducting polymer electrode and a reversible electrodeposition optical modulation electrode typically exhibit a difference in potential that may be useful for some applications. For example, this potential difference may provide the inherent voltage threshold needed for matrix addressing of display devices, or be used as the driving force for changing the optical modulation state of a device in the absence of an applied voltage. Short circuiting a silver optical modulation electrode and an oxidized polyaniline counter electrode will generally result in erasure of the silver deposit. On the other hand, a counter electrode comprised of polypyrrole, or another polymer with a relatively negative redox potential, would drive formation of a silver mirror and could be used to provide failsafe of a REM adjustable mirror device to the mirror state. In this case, metal deposition on the polymer counter electrode during mirror erasure would have to be avoided, which may require use of a particular polymer or chemical modification of the polymer surface.

The conducting polymer counter electrode of the present invention may also be advantageous for reversible electrodeposition devices designed to operate at radio frequencies. In this case, the effects of the counter electrode on device performance would be minimal since metal deposition at the counter electrode would be eliminated, and the conducting polymer would switch to the insulating state as metal was removed from the modulation electrode. During switching, the resistance of polyaniline films, for example, changes by five orders of magnitude.

Further features and advantages of the invention will be apparent to those skilled in the art from the following detailed description, taken together with the accompanying drawings.

### BRIEF DESCRIPTION OF THE DRAWINGS

FIG. 1 is a schematic cross-sectional view of transmissive REM device employing a conducting polymer counter electrode.

FIG. 2 is a schematic cross-sectional view of a reversible electrodeposition display device employing a segmented conducting polymer counter electrode.

These figures are not to scale and some features have been enlarged for better depiction of the features and operation of the invention.

### DETAILED DESCRIPTION OF THE INVENTION

This invention provides an optical modulation device for controlling the propagation of electromagnetic radiation comprising a conducting polymer counter electrode, an electrolyte containing ions of an electrodepositable metal, and an optical modulation electrode at which reversible metal electrodeposition occurs. As used in this document, the term “optical” encompasses radiation throughout the electromagnetic spectrum, including visible light, infrared radiation, and radio frequency radiation. The optical modulation device of the present invention may be designed to control the propagation of electromagnetic radiation in any wavelength region. The term “transparent” denotes substantially high transmission of the electromagnetic radiation whose propagation is controlled by the optical modulation device. The term “conducting polymer” also encompasses the term “electroactive conjugated polymer”, which is also used in the literature.

Optical modulation devices according to the present invention generally include an edge seal between the two electrodes to contain the electrolyte and to inhibit intrusion of environmental species, oxygen and water, for example, which may be detrimental to the device performance. The edge seal is not an object of the present invention and is therefore not included in the figures or the description of the invention. This is also the case for auxiliary equipment needed to switch the device, such as buss bars and electrical drive circuitry and equipment. The edge seal for the device of the present invention may be fabricated by various standard methods, which typically involve use of an epoxy (cured by heat and/or light) that is compatible with the electrolyte. The device is preferably switched by controlling the cell voltage, rather than the current. The cell voltage may be controlled at constant positive and negative values, or may be varied. The cell voltage may also be programmed to provide faster or more uniform switching, as described in U.S. patent application Ser. No. 10/256,841 to Tench et al. (filed Sep. 27, 2002). Suitable switching devices are known in the art.

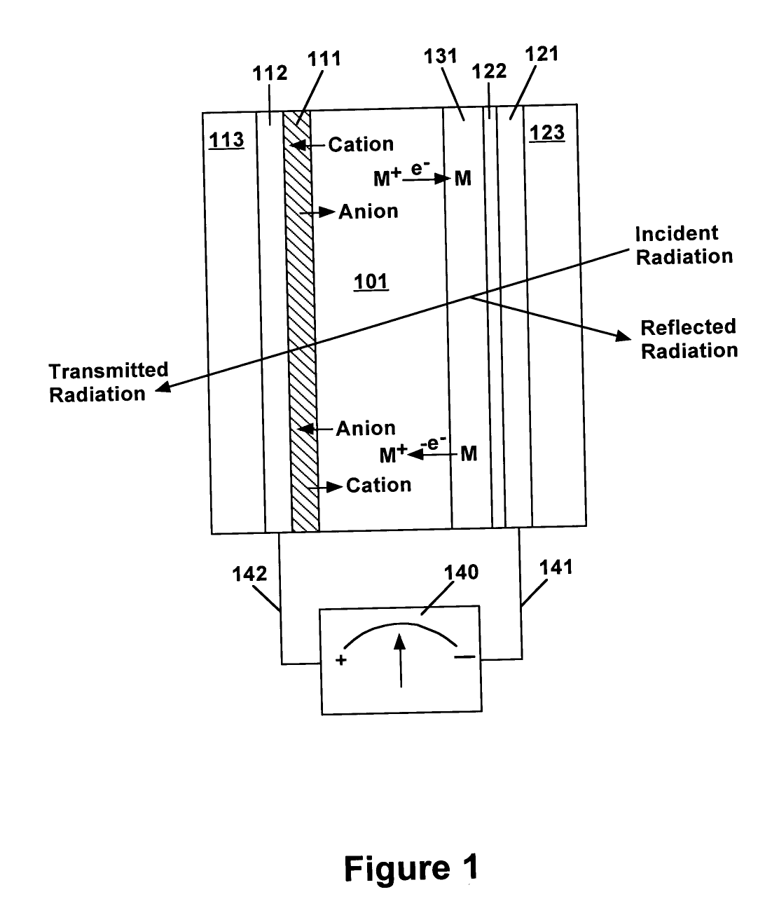

FIG. 1 illustrates a preferred embodiment of the present invention, which is a REM smart window device employing a conducting polymer counter electrode and an optical modulation electrode on which a highly-reflective layer of metal is reversibly electrodeposited. The conducting polymer counter electrode comprises a conducting polymer layer 111 preferably deposed on a layer of electrically conductive material 112 that is deposed on a substrate 113. Conductive layer 112 tends to improve the switching uniformity of the device by reducing the counter electrode sheet resistance. Conducting polymers typically exhibit high electrical resistivity in the reduced state, which may cause nonuniform and/or slow switching when conductive layer 112 is not employed. For a transmissive device, conductive layer 112 and substrate 113 should be substantially transparent to radiation of the wavelengths for which propagation is to be controlled. Metallic oxides, indium tin oxide (ITO) and fluorine doped tin oxide (FTO), for example, are typically used as transparent conducting materials for the visible and near infrared wavelength regions. Other metallic oxides that might be used in various wavelength regions include aluminum-doped zinc oxide, antimony-doped tin oxide, indium oxide, fluorine-doped indium oxide, aluminum-doped tin oxide, phosphorus-doped tin oxide, indium zinc oxide, and cadmium oxide. Substrate 113 may comprise one of a variety of glasses and plastics.

A thin metallic or metallic oxide layer (not shown in FIG. 1) may be used between conductive layer 112 and conducting polymer layer 111 to improve adhesion. A metallic oxide adhesion layer, ceria, for example, is preferred. A metallic adhesion layer preferably comprises a noble metal (platinum, iridium, gold, osmium, palladium, rhenium, rhodium, ruthenium, and alloys thereof) but less noble metals (nickel, cobalt, titanium and chromium, for example) may be used. For a transmissive device, the adhesion layer should be sufficiently thin (<20 Å) to be substantially transparent to the propagated radiation.

For an adjustable reflectivity device not involving optical transmission, conductive layer 112 may comprise a thick layer or sheet of a metal or alloy, and substrate 113 may not be needed or may comprise an opaque material. In such cases, conductive layer 112 may comprise any metal or alloy providing sufficient adhesion and stability with respect to the conducting polymer, and may be any thickness suitable from a mechanical standpoint.

For the transmissive REM device of FIG. 1, the optical modulation electrode comprises a nucleation layer 122 of a noble metal on a transparent conductor layer 121 deposed on a substrate 123. Nucleation layer 122 enhances nucleation on the surface of transparent conductor 121 so that highly-reflective metal electrodeposits are obtained during device operation. Nucleation layer 122 preferably comprises a noble metal that is sufficiently thin to be substantially transparent to the radiation. Suitable noble metals for nucleation layer 122 include platinum, iridium, gold, osmium, palladium, rhenium, rhodium, ruthenium, and alloys thereof. Materials that may be used for transparent conductor layer 121 include indium tin oxide (ITO), fluorine doped tin oxide (FTO), aluminum-doped zinc oxide, antimony-doped tin oxide, indium oxide, fluorine-doped indium oxide, aluminum-doped tin oxide, phosphorus-doped tin oxide, indium zinc oxide, and cadmium oxide. Substrate 123 may comprise one of a variety of transparent glasses and plastics. A preferred optical modulation electrode comprises a platinum nucleation layer (15 Å thick) on a layer of indium tin oxide (10-20 ohm/square sheet resistance) deposed on a glass substrate.

The electrodepositable metal may comprise silver, copper, bismuth, tin, zinc, cadmium, mercury, indium, lead, antimony, thallium, or alloys thereof. A preferred electrodepositable metal is silver, which provides high reflectivity (needed for REM devices) and is electrodeposited in a one-electron process, which requires a minimum of charge for switching and tends to enhance device switching speed. In some electrolytes, copper electrodeposition is also a one-electron process.

Electrolyte 101 typically also contains complexing anions, which tend to stabilize the electrodepositable metal ions in the electrolyte and improve the electrodeposit properties. Preferred anions include halides (fluoride, chloride, bromide and iodide) and pseudohalides (cyanide and thiocyanate). An excess of complexing anions, added as salts of unreactive ions (e.g., Li⁺, Na⁺ and K⁺), may be employed to further stabilize the electrodepositable metal ions, improve electrodeposit reflectivity, and enhance erasure of the electrodeposited metal.

Electrolyte 101 (see FIG. 1) is preferably an ionic liquid electrolyte, which avoids solvation effects that tend to shorten the cycle life of conducting polymer electrochromic devices. A polyaniline electrode in a butylmethylimidazolium fluoroborate ionic liquid electrolyte exhibited stable electrochromic behavior for more than one million cycles [W. Lu, A. G. Fadeev, B. Qi, and B. J. Mattes, J. Electrochem. Soc. 151(2), H33 (2004)]. For the device of the present invention, the ionic liquid electrolyte must also contain ions of an electrodepositable metal. U.S. Pat. No. 6,552,843 to Tench et al. describes some ionic liquid electrolytes useful for reversible electrodeposition optical modulation devices. Such ionic liquid electrolytes typically contain ions of an electrodepositable metal, halide (or pseudohalide) anions, and heterocyclic organic cations having one or two nitrogen atoms in a five- or six-member ring structure. Examples of suitable organic cations include N-methylpyrrolidiinum (MP⁺), pyrrolidinium (P⁺), N-butylmethylpyrrolidinium (BMP⁺), 1-ethylimidazolium (EI⁺), 1-ethyl-3-methylimidazolium (EMI⁺), 2-methyl-1-pyrrolinium (2M1P⁺) and N-butylpyridinium (BuPy⁺). Preferred electrodepositable metals for ionic liquid electrolytes include silver, copper, tin, zinc, and alloys thereof. Ionic liquids made with these metals tend to be substantially transparent to visible light. Some ionic liquids tend to slowly crystallize at room temperature to form opaque solids but such crystallization may be suppressed by use of low-symmetry cations (such as those given as examples above), mixtures of different cations, or mixed anions. A preferred ionic liquid electrolyte for the device of the present invention comprises ethylmethylimidazolium chloride (EMIC), butylmethylpyrrolidinium chloride (BMPC) and silver chloride in the molar ratios 0.9:0.1:0.75, respectively.

Electrolytes based on nonaqueous or aqueous solvents may also be used to practice the invention. U.S. Pat. Nos. 6,111,685 and 6,400,491 to Tench et al. describe nonaqueous electrolytes suitable for reversible electrodeposition optical modulation devices. A preferred nonaqueous solution comprises 1.5 M AgI and 2.0 M LiBr in a γ-butyrolactone (GBL) solvent, which may also contain highly dispersed silica (HDS) added to produce a gelled electrolyte and/or dispersed carbon added to blacken the electrolyte so as to reduce background radiation reflection. Nonaqueous solvents that may be employed include γ-butyrolactone, γ-valerolactone, propylene carbonate, ethylene carbonate, dimethylcarbonate, benzonitrile, dimethylsulfoxide, glycerol, sulfolane, tetraglyme, and mixtures thereof. The prior art literature [e.g., S. Zaromb, J. Electrochem. Soc. 109(10), 903 (1962)] describes aqueous electrolytes that might also be used for some devices.

The electrolyte employed for the present invention may be rendered more viscous, semi-solid or solid by addition of organic (e.g., polyacrylates) or inorganic (e.g., HDS) gelling agents. Inorganic or organic materials, including suspended carbon and dissolved dyes, may be added to the electrolyte to impart a desired color or to reduce background reflection.

The metal and transparent conductor layers for the device of the invention may be deposited by a variety of standard methods. A preferred deposition method is sputtering. Suitable transparent conductor layers may also be deposited by electron-beam deposition or spray pyrolysis, for example.

FIG. 1 also illustrates operation of the device of the present invention. In the absence of an electrodeposited metal layer 131, the optical modulation electrode is substantially transparent to incident radiation. In this case, conducting polymer layer 111 is in the fully reduced state so that the counter electrode is also substantially transparent to the incident radiation. A voltage may be applied between the two electrodes via voltage source 140 and wires 141 and 142. Application of a negative voltage to the optical modulation electrode (layers 121 and 122) relative to the conducting polymer electrode (layers 111 and 112) causes electrodepositable metal ions M⁺ in electrolyte 101 to electrodeposit as metal layer 131 (on the optical modulation electrode). The counter electrode reaction during such metal electrodeposition is electrochemical oxidation of conducting polymer layer 111, which is accompanied by transport of anions from conducting polymer layer 111 to electrolyte 101, and/or transport of cations from electrolyte 101 to conducting polymer layer 111. Metal layer 131 reflects at least a fraction of the incident radiation so that the amount of transmitted radiation is reduced. As the thickness of metal layer 131 increases, the fraction of reflected radiation tends to increase and the fraction of transmitted radiation tends to decrease. For a transmissive device of the type illustrated in FIG. 1, the conducting polymer material is preferably colored in the oxidized state and transparent in the reduced state. In this case, conducting polymer layer 111 is transparent in the absence of metal layer 131, and becomes colored during metal electrodeposition on the optical modulation electrode. The colored conducting polymer layer tends to reduce light reflection from the electrolyte side of the optical modulation electrode, which may be desirable for some REM smart window devices. When the two electrodes are short circuited (or the polarity of the voltage from voltage source 140 is reversed), metal layer 131 tends to dissolve in electrolyte 101 so as to decrease the fraction of reflected radiation and increase the fraction of transmitted radiation. In this case, the counter electrode reaction is reduction of polymer layer 111, which is accompanied by transport of anions from electrolyte 101 to conducting polymer layer 111, and/or transport of cations from conducting polymer layer 111 to electrolyte 101. For the device of the present invention, the counter electrode oxidation and reduction reactions are localized on the immobile conducting polymer so that no mobile energetic species are introduced into electrolye 101.

A wide variety of conducting polymers may be used for the counter electrode of the present invention, including polyaniline, polypyrrole, polythiophene, polyphenylene, polyphenylenevinylene, polyphenylenesulfide, polyfluorene, polypyridine, polypyidalvinylene, polyfuran, polyacetylene, polyquinone, polycarbazole, polyazulene, polyindole, and derivatives and mixtures thereof. Polymer derivatives typically involve additions of substituent groups to the polymer backbone. For example, the conducting polymers poly(3,4-ethylenedioxythiophene) and poly(3-alkylthiophene) are derivatives of polythiophene. For devices that do not transmit radiation, the electrochromic properties of the conducting polymer tend to be relatively unimportant. For transmissive devices, the conducting polymer is preferably transparent in the reduced state, when high transmission is desired, and colored in the oxidized state so as to enhance the optical modulation effect of deposited metal and hide the backside of mirror devices. Preferred conducting polymers for the counter electrode of the present invention include polyaniline, polypyrrole, polythiophene, and derivatives and mixtures thereof.

A preferred conducting polymer for smart window devices is polyaniline, which is colored (blue/green) in the oxidized state and is almost colorless in the reduced state. The redox potential for polyaniline also tends to be relatively positive compared to the Ag/Ag⁺ potential, at least in chloride-based ionic liquid electrolytes, so that deposition of the electrodepositable metal on the polymer surface (as it is removed from the optical modulation electrode) can readily be avoided. At least in some electrolytes, a silver deposit can be erased completely by shorting an optical modulation electrode to a polyaniline counter electrode, which precludes deposition of the metal on the polyaniline surface. Polypyrrole is also transparent in the reduced state but has a relatively negative redox potential so that deposition of the metal on the polypyrrole surface is a concern. Such metal deposition could be suppressed via chemical modification of the polymer surface, by coating the polymer surface with a thin metallic oxide layer, for example. A counter electrode comprised of polypyrrole, or another polymer with a relatively negative redox potential, would drive formation of a silver mirror and could be used to provide failsafe of a REM adjustable mirror device to the mirror state. Conducting polymers that are colored in the reduced state, which may be particularly useful for reversible electrodeposition devices designed to modulate infrared radiation, include poly(3,4-ethylenedioxythiophene) and poly(3-alkylthiophene) materials.

The conducting polymer film may be deposited by a variety of means, including electrochemical or chemical deposition from monomer or oligomer species dissolved in a solution, and spin, dip or spray coating of polymer species dissolved or suspended in a liquid. Suitable methods for depositing conducting polymer films are known in the art. For example, many polythiophene films can be deposited from solution in their reduced states. Conducting polymers are typically electrodeposited in the oxidized form (anion-doped). Oxidized polyaniline films containing dichloroacetate (CHCl₂CO₂⁻) anions may be deposited from a formic acid solution containing such anions. The conducting polymer counter electrode film is preferably converted (if necessary) to the reduced state prior to cell assembly so that no electrodepositable metal charge is needed on the mirror electrode. In this case, metal electrodeposited on the optical modulation electrode from the electrolyte is renewed from the electrolyte during each cycle so that metal redistribution is not an issue. Excess charge capacity may be incorporated in the conducting polymer film to offset any loss of electrodepositable metal or conducting polymer resulting from chemical reaction with oxygen or electrolyte impurities. An ultraviolet (UV) stabilizer, Uvinul 3035, for example, may be included in the electrolyte to reduce degradation of the conducting polymer by ultraviolet light.

Another embodiment of the present invention is a reversible electrodeposition display device. A typical device of this type involves reversible metal electrodeposition on electrically isolated and separately addressable electrodes, which serve as display elements (e.g., pixels or alpha-numeric segments). Poorly-reflecting electrodeposits may be used on display elements to block or absorb visible light, or an inert surface modification layer may be used to provide mirror deposits that reflect visible light. Reflective elements may be viewed directly or used for projection displays.

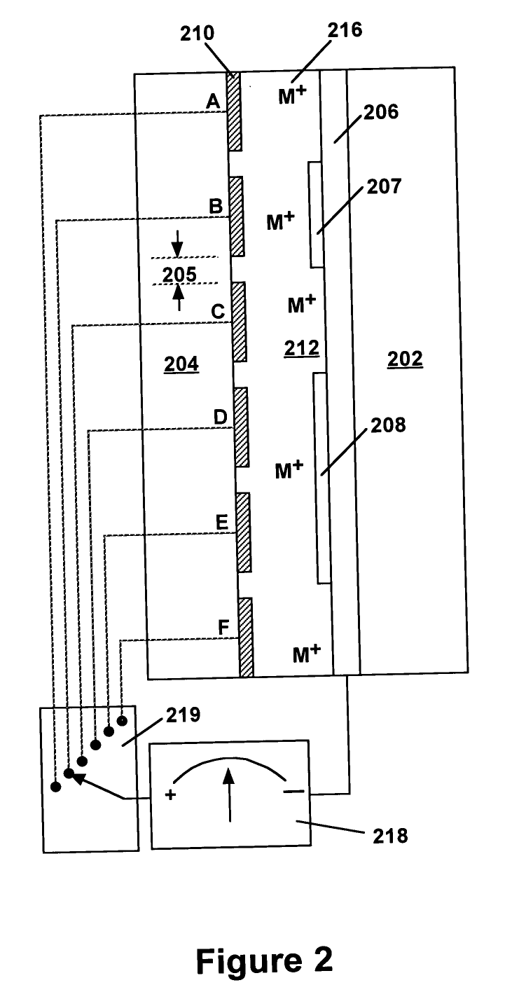

FIG. 2 is a schematic cross-sectional view of a reversible electrodeposition display device employing a segmented conducting polymer counter electrode. In this example, optical modulation electrode 206 is uniformly disposed on substrate 202, and conducting polymer counter electrode 210 is comprised of segments A through F disposed on insulating substrate 204 and separated by a gap of width 205. The segments A through F of counter electrode 210 preferably comprise a conducting polymer layer deposed on a metallic or metallic oxide conducting layer (deposed on substrate 204). These segments may be disposed upon the surface of substrate 204 (as shown), or may be recessed relative to the surface of substrate 204. Electrolyte 212 containing electrodepositable metal ions 216 is disposed between and in contact with optical modulation electrode 206 and counter electrode 210, as well as portions of substrate 204. Each counter electrode segment 210-A through 210-F is electrically connected to electrical switch 219 such that voltage from electrical power source 218 can be applied between optical modulation electrode 206 and one or more segments A through F of counter electrode 210.

As further depicted in FIG. 2, a positive voltage applied to counter electrode segment 210-B tends to electrodeposit a metal layer 207 predominantly in the area of optical modulation electrode 206 directly opposite counter electrode segment 210-B. Deposition of electrodepositable metal in areas of optical modulation electrode 206 substantially distant from counter electrode segment 210-B is suppressed because the voltage is reduced by the greater electrical resistance associated with the longer electrolyte electrical paths. However, the geometric area of the metal layer deposited on the optical modulation electrode is generally larger than the counter electrode segment producing the deposit, as depicted for deposited metal layer 207 and counter electrode segment 210-B in FIG. 2. Under some conditions, metal deposited by application of a positive voltage to adjacent counter electrode segments forms a continuous and substantially uniform metal layer on the optical modulation electrode, as indicated for segments 210-D and 210-E and metal deposit 208 in FIG. 2. Applying a negative voltage to a given counter electrode segment tends to cause metal deposited on the optical modulation electrode in the localized area opposite to that counter electrode segment to dissolve into the electrolyte. The propagation of light for a particular localized area of optical modulation electrode 206 is determined by the thickness of the electrodeposited metal layer in that area, which can be adjusted by applying a voltage of the appropriate polarity between the optical modulation electrode and the corresponding segment of the counter electrode.

### Fabrication of a Preferred Embodiment

The efficacy of the present invention was demonstrated via construction and testing of transmissive REM devices employing a mirror optical modulation electrode, a polyaniline (PANI) counter electrode and an ionic liquid electrolyte. The devices had overall dimensions of 4×5 cm, a cell gap of about 0.2 mm, and an active area of about 3 cm square. The mirror electrode comprised 15 ÅPt on 10-ohm ITO on a glass substrate. The counter electrode comprised a polyaniline film on 10-ohm ITO on a glass substrate. The ionic liquid electrolyte comprised ethylmethylimidazolium chloride (EMIC), butylmethylpyrrolidinium chloride (BMPC) and silver chloride in the molar ratios 0.9:0.1:0.75, respectively. Platers' tape was used to define both the device active area and the cell gap. Electrical contact was made to the ITO layers (outside the active area) using copper adhesive tape. Cell assembly involved placing ionic liquid electrolyte on one of the electrodes, pressing the two electrodes together, wiping off excess electrolyte, and forming an edge seal with epoxy.

Before application of the polyaniline film, a thin layer of ceria was applied to the counter electrode ITO layer to improve adhesion of the polyaniline film. The ceria layer was applied by spin coating (4000 rpm) from a dilute solution of colloidal ceria in methanol, followed by heat treatment at 80° C. overnight.

Polyaniline films were applied by spin coating from a 4-weight percent solution of polyaniline emeraldine base (average molecular weight of about 65K) containing 80% formic acid and 20% dichloroacetic acid. The solution was stirred and briefly heated at 80° C., and was then filtered through a 2.7 μm syringe filter. A polyaniline film was applied from this intense green solution by a spin coating procedure in which the spin rate was slowly increased and then maintained at 750 rpm for 30 seconds. The conducting polymer electrode was then treated overnight under vacuum at room temperature to remove residual solvent. This procedure provided the green oxidized form of the polymer doped with acid anions.

Prior to cell assembly, the polyaniline film was converted to the undoped form by electrochemical reduction in the EMIC-BMPC-AgCl ionic liquid electrolyte (under nitrogen) at 60° C. driven by dissolution of a silver foil electrode. Within about 10 minutes after the electrodes were shorted together, the polyaniline film became transparent and nearly colorless. This conversion process was allowed to continue for 45 minutes. Undoped polyaniline electrodes obtained by this procedure were incorporated in REM cells containing fresh ionic liquid electrolyte. The active area of such cells was clear and transparent, indicating good refractive index matching between the conducting polymer film and the ionic liquid electrolyte.

For such devices, application of a negative voltage of −0.7 to −0.8 V to the optical modulation electrode relative to the conducting polymer electrode produced a practically opaque mirror deposit of silver on the optical modulation electrode within about one minute. For one device, the thickness of the silver deposit was 270 Å after two minutes (based on the charge passed at −0.8 V). The mirror deposit had a gold hue, presumably derived from the conducting polymer coloration. Reflectance of the mirror deposit from the electrolyte side was substantially subdued by the conducting polymer layer, which, during mirror formation, changed from colorless to yellow to green to deep blue-green. The mirror deposit was fully erased within about one minute by shorting the two electrodes together. Cells of this type were cycled between the transparent state and the mirrored/colored state numerous times without apparent change in the mirror quality or the conducting polymer coloration. In the electrolyte used for these experiments, the charge capacity of the conducting polymer was limited by the onset of chloride oxidation to chlorine (at about 0.9 V). In a more electrochemically inert electrolyte, a voltage of up to 1.5 V could be applied to more fully charge the polyaniline film and increase the thickness of the metal deposited on the optical modulation electrode.

The preferred embodiments of the present invention have been illustrated and described above. Modifications and additional embodiments, however, will undoubtedly be apparent to those skilled in the art. Furthermore, equivalent elements may be substituted for those illustrated and described herein, parts or connections might be reversed or otherwise interchanged, and certain features of the invention may be utilized independently of other features. Consequently, the exemplary embodiments should be considered illustrative, rather than inclusive, while the appended claims are more indicative of the full scope of the invention.

1. An optical modulation device for controlling propagation of electromagnetic radiation, comprising:
an optical modulation electrode that is substantially transparent to the radiation;
a counter electrode comprising a layer of a conducting polymer; and
an electrolyte containing a complexing anion and ions of an electrodepositable metal,
said electrolyte being disposed between and in electrical contact with said optical modulation electrode and said counter electrode,
whereby the electrodepositable metal is reversibly electrodeposited on said optical modulation electrode so as to affect propagation of the electromagnetic radiation.

2. The device of claim 1, wherein said optical modulation electrode comprises a layer of a first transparent oxide conductor deposed on a first substrate.

3. The device of claim 2, wherein the first transparent oxide conductor is selected from the group consisting of indium tin oxide, fluorine-doped tin oxide, aluminum-doped zinc oxide, antimony-doped tin oxide, indium oxide, fluorine-doped indium oxide, aluminum-doped tin oxide, phosphorus-doped tin oxide, indium zinc oxide, and cadmium oxide.

4. The device of claim 2, wherein the first substrate comprises a material selected from the group consisting of glasses and plastics.

5. The device of claim 2, wherein said optical modulation electrode further comprises a layer of a first metal deposed on the layer of the first transparent oxide conductor.

6. The device of claim 5, wherein the first metal is a noble metal selected from the group consisting of platinum, iridium, gold, osmium, palladium, rhenium, rhodium, ruthenium, and alloys thereof.

7. The device of claim 1, wherein the conducting polymer is selected from the group consisting of polyaniline, polypyrrole, polythiophene, and derivatives and mixtures thereof.

8. The device of claim 1, wherein the layer of the conducting polymer is deposited by a method selected from the group consisting of electrode position, chemical deposition, dip coating, spin coating, and spray coating.

9. The device of claim 1, wherein the layer of the conducting polymer is deposed on an electrically conducting material.

10. The device of claim 9, wherein the electrically conducting material comprises a second metal.

11. The device of claim 9, wherein the electrically conducting material comprises a layer of a second transparent oxide conductor deposed on a second substrate.

12. The device of claim 11, wherein the second transparent oxide conductor is selected from the group consisting of indium tin oxide, fluorine-doped tin oxide, aluminum-doped zinc oxide, antimony-doped tin oxide, indium oxide, fluorine-doped indium oxide, aluminum-doped tin oxide, phosphorus-doped tin oxide, indium zinc oxide, and cadmium oxide.

13. The device of claim 11, wherein the second substrate comprises a material selected from the group consisting of glasses and plastics.

14. The device of claim 1, wherein said optical modulation electrode filer comprises an adhesion layer of a metallic oxide or a third metal upon which the layer of the conducting polymer is deposed.

15. The device of claim 14, wherein the third metal is a noble metal selected from the group consisting of platinum, iridium, gold, osmium, palladium, rhenium, rhodium, ruthenium, and alloys thereof.

16. The device of claim 1, wherein the electrolyte is selected from the group consisting of ionic liquid, aqueous solution and non-aqueous solution.

17. The device of claim 1, wherein the electrodepositable metal is selected from the group consisting of silver, copper, bismuth, tin, zinc, cadmium, mercury, indium, lead, antimony, thallium, and alloys thereof.

18. The device of claim 1, wherein the electrolyte further comprises anions selected from the group consisting of fluoride, iodide, bromide, chloride, cyanide and thiocyanate.

19. The device of claim 1, wherein the electrolyte is an ionic liquid that includes heterocyclic organic cations selected from the group consisting of N-alkylpyrrolidinium, pyrrolidinium, 1-alkyl-3-methylimnidazolium, N-alkylpyridinium, 2-alkyl-1-pyrrolinium, 1-alkylimidazolium, and mixtures thereof.

20. The device of claim 1, wherein the electrolyte finer comprises a gelling agent.

21. An optical modulation device for controlling propagation of electromagnetic radiation, comprising:
an optical modulation electrode comprising a layer of a transparent oxide conductor deposed on a first transparent glass or plastic substrate;
a counter electrode comprising a layer of a conducting polymer deposed on a layer of an electrically conducting material on a second transparent glass or plastic substrate; and
an electrolyte containing a complexing anion and ions of an electrodepositable metal,
said electrolyte being disposed between and in electrical contact with said optical modulation electrode and said counter electrode,
whereby the electrodepositable metal is reversibly electrodeposited on said optical modulation electrode so as to affect propagation of the electromagnetic radiation.

22. The device of claim 21, wherein said optical modulation electrode further comprises a layer of a first noble metal deposed on the layer of the first transparent oxide conductor and selected from the group consisting of platinum, iridium, gold, osmium, palladium, rhenium, rhodium, ruthenium, and alloys thereof.

23. An optical modulation device for controlling propagation of electromagnetic radiation, comprising:
an optical modulation electrode comprising a thin platinum layer on a layer of indium tin oxide deposed on a first glass or plastic substrate;
a counter electrode comprising a layer of polyaniline conducting polymer on a layer of indium tin oxide deposed on a second glass or plastic substrate; and
an ionic liquid electrolyte containing silver cations and halide anions and disposed between and in electrical contact with said optical modulation electrode and said counter electrode,
whereby silver metal is reversibly electrodeposited on said optical modulation electrode so as to affect propagation of the electromagnetic radiation.
